(19) United States
(12) Patent Application Publication
(10) Pub. No.: US 2010/0011100 A1
(43) Pub. Date: Jan. 14, 2010

(54) Health Check System, Server Apparatus, Health Check Method, and Storage Medium

(75) Inventors: Yoshihiro Kaneko, Fussa-shi (JP); Hideaki Andou, Ome-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Kabushiki Kaisha Toshiba, Tokyo (JP)

(21) Appl. No.: 12/397,136

(22) Filed: Mar. 3, 2009

(30) Foreign Application Priority Data
Jul. 11, 2008 (JP) 2008-181771

(51) Int. Cl. G06F 15/173

(52) U.S. Cl. 709/224

(57) ABSTRACT

According to one embodiment, an information processing apparatus includes a transmission module configured to acquire a status information of a plurality of devices and transmit the status information to a server apparatus via the network. The server apparatus includes a storage module configured to predetermine a condition corresponding to items of status information of the devices or a combination of the items of status information of the plurality of devices and store feedback information defined in correspondence with each condition, and a notification module configured to, when the status information or the combination transmitted by the transmission module matches the predetermined condition, notify, via the network, the information processing apparatus of the feedback information corresponding to the condition and stored in the storage module.

### CROSS-REFERENCE TO RELATED APPLICATIONS

This application is based upon and claims the benefit of priority from Japanese Patent Application No. 2008-181771, filed Jul. 11, 2008, the entire contents of which are incorporated herein by reference.

### BACKGROUND

1. Field

One embodiment of the present invention relates to a server apparatus having a client computer health check function and, more particularly, to a health check system, server apparatus, health check method, and storage medium capable of sending health check information from a server apparatus to a client computer.

2. Description of the Related Art

An unexpected failure in a device such as a computer that is, e.g., being used by a user is generally detrimental to the convenience of the user. For example, if the hard disk drive has crashed before backing up data, the user may be unable to continue processing in the computer. To predict such a failure, for example, Jpn. Pat. Appln. KOKAI Publication No. 2006-163520 discloses a technique of counting the number of errors in the CPU, memory, or HDD of a computer, and when the counted number of errors has reached a predetermined threshold, outputting a warning for failure prediction.

However, the technique disclosed in Jpn. Pat. Appln. KOKAI Publication No. 2006-163520 only determines a failure in a specific device mounted in a computer simply based on deterioration in the quality of the device.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary view showing the concept of the arrangement of a health check system according to an embodiment of the present invention;

FIG. 2 is an exemplary block diagram showing the main arrangement of a server apparatus according to the embodiment;

FIG. 3 is an exemplary block diagram showing the main arrangement of a computer according to the embodiment;

FIG. 4 is an exemplary flowchart for explaining a health check method using the health check system and the server apparatus according to the embodiment and processing of a storage medium;

FIG. 5 is an exemplary view schematically showing an example of table information which stores condition information and feedback information of the server apparatus according to the embodiment; and

FIG. 6 is an exemplary view schematically showing another example of table information which stores condition information and feedback information of the server apparatus according to the embodiment.

### DETAILED DESCRIPTION

Various embodiments according to the invention will be described hereinafter with reference to the accompanying drawings. In general, according to one embodiment of the invention, a health check system including an information processing apparatus having a plurality of devices, and a server apparatus for receiving status information representing an operation state of each of the plurality of devices from the information processing apparatus via a network, the information processing apparatus comprising a transmission module configured to acquire the status information of the plurality of devices and transmit the status information to the server apparatus via the network, and the server apparatus includes: a storage module configured to predetermine a condition corresponding to items of status information of the devices or a combination of the items of status information of the plurality of devices and store feedback information defined in correspondence with each condition; and a notification module configured to, when one of the status information and the combination transmitted by the transmission module matches the predetermined condition, notify, via the network, the information processing apparatus of the feedback information corresponding to the condition and stored in the storage module.

An embodiment of the present invention will now be described with reference to the accompanying drawing.

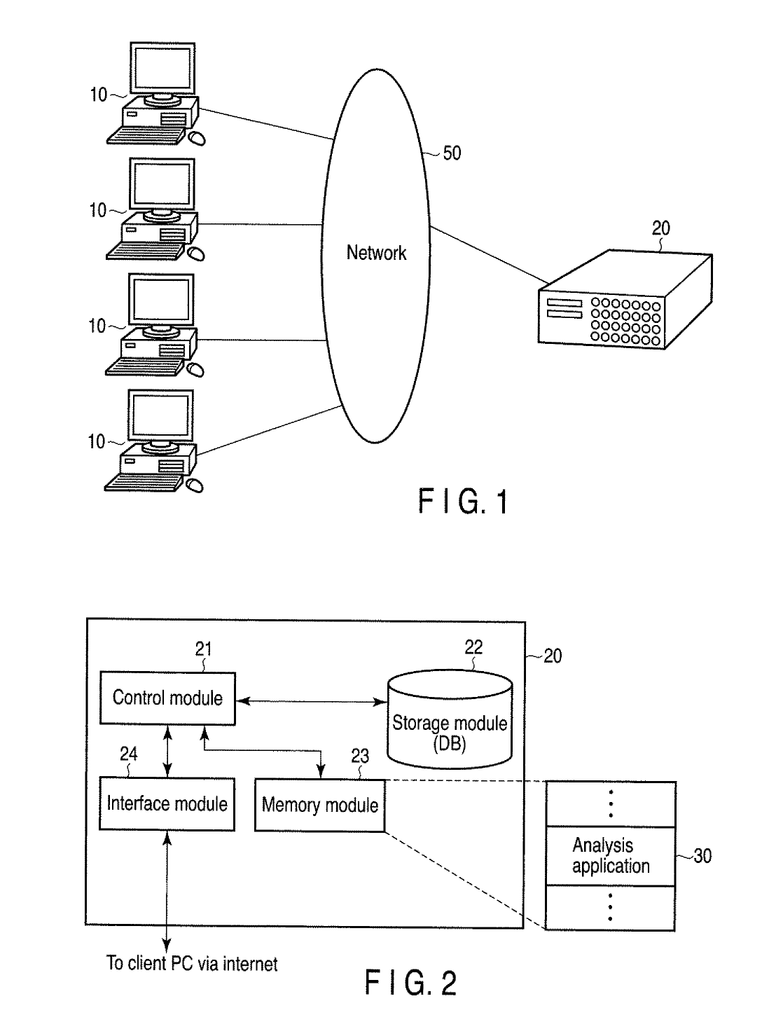

The arrangements of a health check system and a server apparatus according to an embodiment of the present invention will be described with reference to FIGS. 1 and 2. Health check indicates here defining a state of a personal computer operating as intended as a health state, checking the degree of health of the operation of the computer, and notifying the computer of the health state as needed (feedback). The health check system also has a function of obtaining a health state based on information about the daily operation state of each personal computer and checking whether a computer shows a sign of, e.g., a failure.

Referring to FIG. 1, the health check system includes client computers 10 and a server apparatus 20.

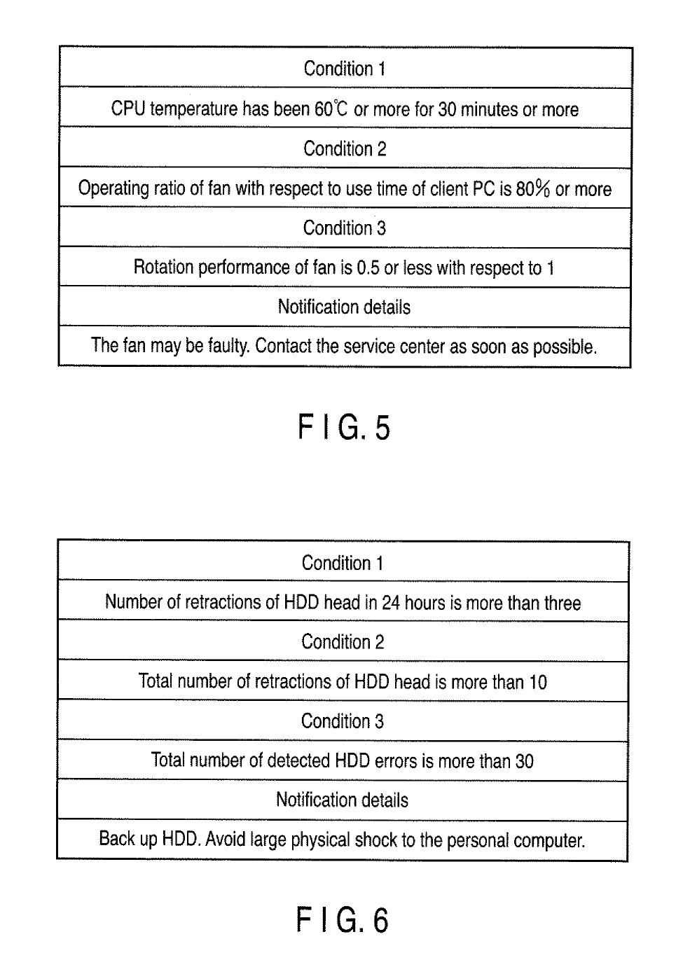

Each client computer 10 acquires, by a logging application, items of status information representing the operation states of a plurality of devices such as a CPU and a cooling fan (to be described later) in the client computer 10 and transmits the information to the server apparatus 20, e.g., periodically. The server apparatus 20 includes databases corresponding to the models of the client computers 10 in advance. Each database stores predetermined conditions (to be described later: FIGS. 5 and 6) for the acquired status information of the plurality of devices. If the items of status information of the plurality of devices received from the client computer 10 satisfy the predetermined conditions, the server apparatus 20 transmits notification details (feedback information, feedback message) corresponding to the conditions to the client computer 10.

FIG. 2 is a block diagram showing the main arrangement of the server apparatus 20. The server apparatus 20 includes a control module 21, storage module 22, memory module 23, and interface module 24. The control module (notification module) 21 determines whether items of status information (log information) of the plurality of devices received from each client computer 10 satisfy predetermined conditions. The control module 21 also controls processing of transmitting/receiving data to/from the client computers 10 via a network 50 such as the Internet. The storage module 22 stores feedback information (e.g., failure prediction notification information and information of exchange requiring components provided by manufacturers) dedicated to each model of the client computers 10, the information of the predetermined conditions (to be described later: FIGS. 5 and 6), an analysis application 30 to analyze items of status information of the plurality of devices received from each client computer 10, and an operating system (OS). The memory module 23 is used by the control module 21 to load the analysis application 30 and the OS stored in the storage module 22 and execute processing. The interface module 24 is an interface device such as a network controller which connects the server apparatus 20 to the network 50 such as the Internet to transmit/receive data to/from the client computers 10.

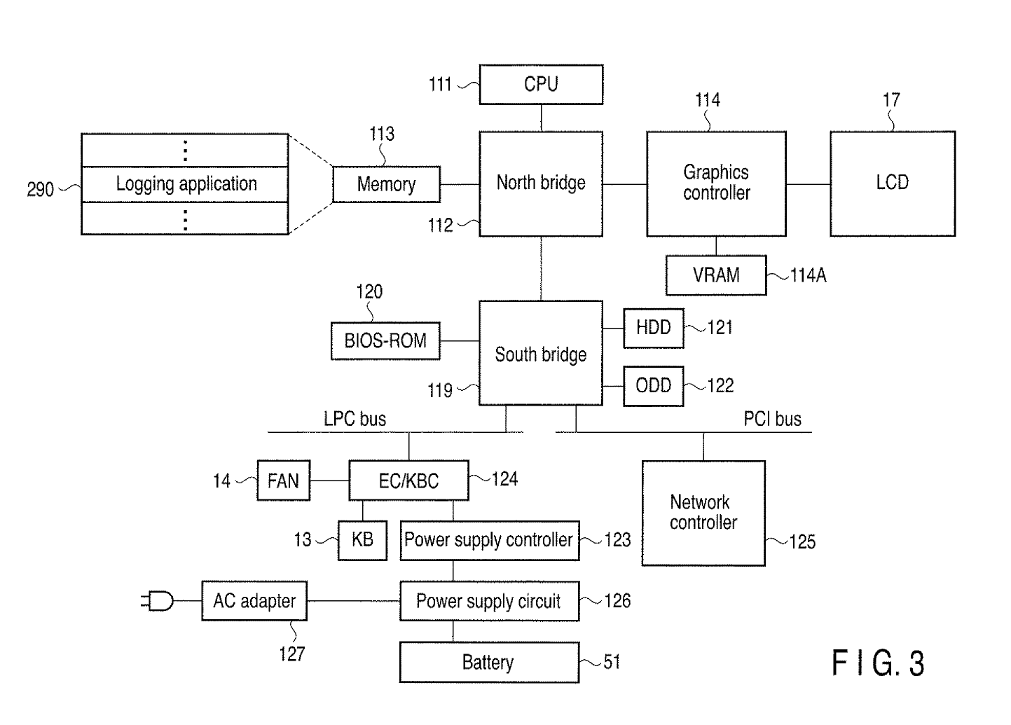

FIG. 3 is a block diagram showing the main arrangement of the client computer 10.

The client computer 10 includes a CPU 111, north bridge 112, (main) memory 113, graphics controller 114, south bridge 119, BIOS-ROM 120, hard disk drive (HDD) 121, optical disk drive (ODD) 122, embedded controller/keyboard controller IC (EC/KBC) 124, fan 14, power supply controller 123, power supply circuit 126, battery 51, AC adapter 127, and network controller 125. Note that the HDD 121 has a function of retracting the read head upon, e.g., detecting a predetermined acceleration.

The CPU 111 is a processor provided to control the operation of the computer 10 and executes an operating system and various applications such as a logging application 290, which are loaded from the HDD 121 to the memory 113.

The logging application 290 monitors the operation states of a plurality of arbitrary devices of the above-described devices and stores status information. When monitoring the operation state of each device, the logging application 290 acquires the information unique to each device (information to identify each device) in addition to the status information. In this case, the logging application 290 acquires, for example, the temperature and operating time of the CPU, the operating time of the client computer 10, the operating time and operating ratio of the fan, the actual number of rotations of the fan with respect to its rotation performance, the operating time of the HDD 121, the number of retractions of the head of the HDD, the S.M.A.R.T. information of the HOD, the number of depressions of each key, the operating count and time of the client computer 10 for each state (Sx), and the number of errors. The devices are not limited to those described above. The logging application 290 can acquire information of the operation states of various devices.

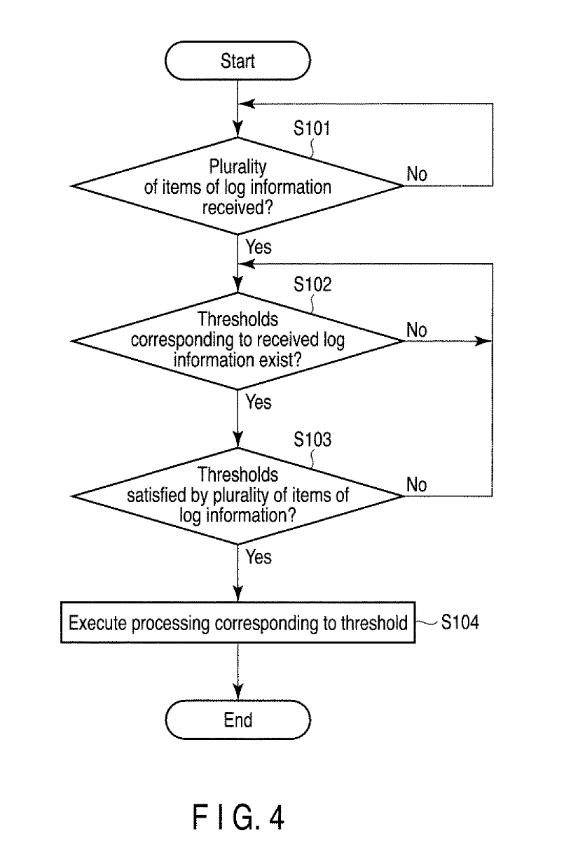

A health check method using the health check system and the server apparatus according to the present invention having the above-described arrangement and processing of a storage medium will be described with reference to the flowchart in FIG. 4.

The CPU 111 of the computer 10 loads the logging application 290 to the memory 113. The logging application 290 controlled by the CPU 111 performs logging (monitoring and storing) of status information representing the operation states of various kinds of devices in the computer 10. The status information includes, e.g., the temperature and operating time of the CPU, the operating time of the computer 10, the operating time, the number of rotations, and the operating ratio of the fan 14, the operating time of the HDD 121, the number of retractions of the head of the HDD (if the HDD 121 has a function of retracting the read head upon detecting a predetermined acceleration), the number of read and write errors of the HDD 121 (acquired from, e.g., S.M.A.R.T. of the HDD 121), the number of read errors and the operating time of the ODD 122, the number of read and write errors and the operating time of a solid-state drive (SSD), the number of depressions of each key (acquired by, e.g., the EC/KBC 124), the number of connection operations for each connector (acquired by, e.g., the EC/KBC 124), the number open/close operations of the cover if the computer 10 is a notebook computer having a closable cover portion, the number of state transitions and the time of each state of the computer 10 (e.g., the number of transitions to a state Sx and the time in state Sx), and the temperature and temperature change of each device (acquired by, e.g., the BIOS-ROM 120). In this case, the status information is transmitted to the server apparatus 20 together with the unique information of each device to identify the type of each device (e.g., information to enable discrimination between the HDD and the CPU). Note that the status information is not limited to the above-described examples, and can include various kinds of acquirable information.

The logging application 290 transmits the acquired status information of each device to the server apparatus 20 via the network 50 such as the Internet at an arbitrary timing. The status information of each device can be transmitted either periodically or in accordance with a predetermined trigger. The status information (and the unique information of each device) acquired by logging of the logging application 290 is stored in the HOD 121 of the computer 10.

As shown in FIG. 4, upon receiving the status information (log information) of each device from the client computer 10 (YES in block S100), i.e., upon receiving a plurality of items of device status information, the analysis application 30 of the server apparatus 20 determines whether thresholds corresponding to the plurality of items of device status information exist (block S102). In this case, the storage module 22 of the server apparatus 20 stores, in advance, feedback information for each model of the client computers 10 and predetermined conditions corresponding to a plurality of items of device status information. As the predetermined conditions and feedback information, for example, three conditions (predetermined conditions) and notification details (feedback information) are stored, as shown in FIG. 5. More specifically, condition 1 is “The temperature of the CPU 111 of the client computer 10 has been, e.g., 60° C. or more for 30 minutes or more”. Condition 2 is “The operating ratio of the fan 14 with respect to the use time of the client computer 10 is, e.g., 80% or more”. Condition 3 is “The rotation performance of the fan 14 is, e.g., 0.5 or less with respect to i”. The details to be sent to the client computer 10 when the three conditions are satisfied are stored as “the fan may be faulty. Contact the service center as soon as possible”. Appropriately combining the above-described predetermined conditions and notification details corresponding to them enables finding and notification of failures and errors. When the conditions are set to enable to determine deterioration in the health state of the client computer 10 which is apparently operating normally, it may be possible to notify the user of a failure sign and avoid any accident before the client computer 10 breaks down.

If it is determined in block S102 that the analysis application 30 has received a plurality of items of device status information, and there are thresholds corresponding to the plurality of items of received device status information (YES in block S102), and for example, if it is determined after reception of the status information of the CPU 111 that a corresponding threshold is stored in the storage module 22 (FIG. 5), the process advances to block S103. If the analysis application 30 determines that the plurality of items of received status information satisfy the thresholds (YES in block S103), the process advances to block S104. More specifically, the analysis application 30 determines based on the received status information of the CPU 111 that condition 1 shown in FIG. 5 is satisfied, based on the received status information of the operating ratio of the fan 14 with respect to the use time of the client computer 10 that the operating ratio of the fan 14 is 80% or more, and finally based on the received status information of the number of rotations of the fan 14 that the actual rotation performance of the fan 14 is 0.5 or less with respect to 1. If the three conditions are satisfied, a feedback message “The fan may be faulty. Contact the service center as soon as possible” is sent to the client computer 10 via the network 50 (block S104). The client computer 10 displays the received notification details on a display device such as an LCD 17.

Conditions 1 to 3 of the above-described embodiment are stored in the storage module 22 of the server apparatus 20 and updated as needed in accordance with the status information of each device received from the client computer 10. For example, the items of device status information received by the server apparatus 20 are accumulated. If it turns out at the service center in, e.g., 90% or more of cases that the fan 14 failed when its rotation performance of condition 3 shown in FIG. 5 was 0.4 or less, the threshold of the rotation performance of the fan 14 of condition 3 can be updated from 0.5 to 0.4.

The status information of each device accumulated in the server apparatus 20 can be output as a file or a print having a predetermined format as needed. The status information of each device accumulated in the server apparatus 20 can be used as data for design or development of the client computer 10.

Alternatively, as shown in FIG. 6, condition 1 is “The number of retractions of the head of the HDD 121 in 24 hours is more than three.” Condition 2 is “The total number of retractions of the head of the HDD 121 is more than 10”. Condition 3 is “The total number of detected HDD 121 errors is more than 30”. If the three conditions are satisfied, the server apparatus 20 may transmit, to the client computer 10, notification details “Back up the HDD. Avoid large physical shock to the personal computer.” In the above-described embodiment, three conditions are used. However, the number of conditions is not limited to three.

The server apparatus 20 receives status information and unique information of each device from the client computers 10 and therefore includes databases corresponding to the models of the client computers 10 of its own brand. If a predetermined error occurs in a certain model, error information is transmitted to only the logging applications 290 in the client computers 10 of the model, thereby quickly notifying the users of the model of the error information. If a Q & A database for the model exists on a Web site, the database can automatically be updated simultaneously with the notification.

If a virtual memory area of a predetermined capacity or more is allocated in the HDD 121, the server apparatus 20 can transmit a notification to the client computer 10 to prompt the user to increase the capacity of the memory 113 by acquiring the status information of the memory 113 and the status information of the virtual memory area.

The health check described in the above embodiment can be inhibited by disabling the logging application 290.

It is an object of the present invention to provide a health check system, server apparatus, health check method, and storage medium capable of predicting a failure based on the operation states of a plurality of devices provided in a personal computer.

According to the above-described embodiment, it is possible to more specifically check the health state of a computer by receiving status information from a plurality of devices and predicting a failure. When the databases corresponding to the respective client computers are used, a health check optimum for each model of the client computers 10 can be carried out.

All the procedures of control processing of the embodiment can be implemented by software. It is therefore possible to easily obtain the same effect as in the embodiment only by installing a program for executing the procedures in a computer having an optical disk drive with a power saving operation mode via a computer-readable storage medium.

A module can be accomplished in software and hardware.

Note that the present invention is not exactly limited to the above embodiments, and constituent elements can be modified in the execution stage without departing from the spirit and scope of the invention.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A health check system including an information processing apparatus having a plurality of devices, and a server apparatus for receiving status information representing an operation state of each of the plurality of devices from the information processing apparatus via a network,
the information processing apparatus comprising a transmission module configured to acquire the status information of the plurality of devices and transmit the status information to the server apparatus via the network, and
the server apparatus comprising:
a storage module configured to predetermine a condition corresponding to items of status information of the devices or a combination of the items of status information of the plurality of devices and store feedback information defined in correspondence with each condition; and
a notification module configured to, when one of the status information and the combination transmitted by the transmission module matches the predetermined condition, notify, via the network, the information processing apparatus of the feedback information corresponding to the condition and stored in the storage module.

2. The system of claim 1, wherein the storage module accumulates the items of acquired status information of the plurality of devices and updates the predetermined condition based on the items of accumulated status information of the plurality of devices.

3. The system of claim 2, wherein the storage module outputs the items of stored status information of the plurality of devices in a predetermined format.

4. A server apparatus for receiving, via a network, status information representing an operation state of each of a plurality of devices from an information processing apparatus having the plurality of devices, comprising:
a storage module configured to predetermine a condition corresponding to items of status information of the plurality of devices or a combination of the items of status information of the plurality of devices and store feedback information defined in correspondence with each condition;
a reception module configured to acquire the items of status information of the plurality of devices from the information processing apparatus and receive the status information via the network; and
a notification module configured to, when the items of status information of the devices or the combination received by the reception module matches the predetermined condition, notify, via the network, the information processing apparatus of the feedback information corresponding to the condition and stored in the storage module.

5. The apparatus of claim 4, wherein the storage module outputs the items of stored status information of the plurality of devices in a predetermined format.

6. A health check method of an information processing apparatus having a plurality of devices, which is used in a server apparatus for receiving status information representing an operation state of each of the plurality of devices from the information processing apparatus via a network, the method comprising block S of:
predetermining a condition corresponding to items of status information of the plurality of devices or a combination of the items of status information of the plurality of devices and storing feedback information defined in correspondence with each condition in a storage module;
acquiring the status information from the information processing apparatus and receiving the status information via the network; and
when the items of status information of the devices or the combination received matches the predetermined condition, notifying, via the network, the information processing apparatus of the feedback information corresponding to the condition and stored in the storage module.

7. The method of claim 6, wherein the storage module outputs the items of stored status information of the plurality of devices in a predetermined format.

8. A storage medium storing a program used in a server apparatus for receiving, via a network, status information representing an operation state of each of a plurality of devices from an information processing apparatus having the plurality of devices, the program causing a computer to execute:
a storage procedure of predetermining a condition corresponding to items of status information of the plurality of devices or a combination of the items of status information of the plurality of devices and storing feedback information defined in correspondence with each condition in a storage module;
a reception procedure of acquiring the status information from the information processing apparatus and receiving the status information via the network; and
a notification procedure of, when the items of status information or the combination received matches the predetermined condition, notifying, via the network, the information processing apparatus of the feedback information corresponding to the condition and stored in the storage module.
